(19) United States
(12) Patent Application Publication
(10) Pub. No.: US 2018/0191283 A1
(43) Pub. Date: Jul. 5, 2018

(54) Motor Control Device and Electric Power Steering Device Mounting the Same

(71) Applicant: Hitachi Automotive Systems, Ltd., Hitachinaka-shi, Ibaraki (JP)

(72) Inventors: Shigehisa AOYAGI, Tokyo (JP); Toshiyuki AJIMA, Tokyo (JP); Masaki KASHIMA, Atsugi-shi (JP); Hiroyuki OOTA, Atsugi-shi (JP)

(21) Appl. No.: 15/738,781

(22) PCT Filed: Jun. 14, 2016
(86) PCT No.: PCT/JP2016/067645

§ 371 Date: Dec. 21, 2017

(30) Foreign Application Priority Data
Jul. 3, 2015 (JP) 2015-134030

(51) Int. Cl. H02P 21/00; B62D 5/04

(52) U.S. Cl. CPC H02P 21/0089; B62D 5/046; B62D 5/0481

(57) ABSTRACT

Provided is a motor control device that realizes a high power drive and keeps a steering feeling having a good responsiveness with respect to an operation amount of a steering wheel like an electric power steering device while suppressing an input current to be equal to or lower than a predetermined value in response to a power source management as a vehicle. The motor control device of the invention includes an inverter which converts a DC input current from a DC voltage source into an AC current on the basis of a rotor phase of a motor and outputs the AC current. In a range in which an input current to the inverter does not exceed a predetermined upper limit while keeping a torque current, a maximum weak field current is calculated by a weak field current command calculation unit and is conducted.

### TECHNICAL FIELD

The present invention relates to a motor control device which receives DC power such as a battery or a capacitor to output AC power, and an electric power steering device which mounts the motor control device.

### BACKGROUND ART

In a motor control device which uses a power conversion device such as an inverter to control a motor, torque of the motor is controlled by adjusting a torque current. In addition, in a region where the motor is at a high speed, a maximum speed which can be driven by a counter electromotive force generated from the motor is fixed. At this time, the counter electromotive force is suppressed small by causing a weak field current to flow as a current weakening the magnetic field of the motor, so that the motor can be driven at a speed higher than the maximum speed. The torque current and the weak field current each are controlled using a vector control theory of an AC motor. Herein, a control value of the weak field current is decided by a motor constant which is a characteristic value of the motor, and the details are disclosed in NPTL 1.

In addition, in a steering mechanism of a vehicle wheel which controls a direction of the vehicle, an electric power steering device is to obtain a steering force from the motor control device to make a turning operation easy according to a driver's steering wheel operation. A use situation of the electric power steering device and a behavior of the motor are described below.

At the time of straight running of a vehicle, there is almost no situation necessary for the turning operation, and thus a required torque of the motor is small. With this regard, the description will be given about a stationary steering in which the vehicle is turned at the time of stopping. At this time, a turning operation is required for a load applied to the wheel, and the motor needs to have a large torque. In addition, since a turning direction of the wheel is large, an operation amount of the steering wheel is increased. The motor rotates at a high speed for the operation amount in order for a driver to feel a steering with an excellent responsiveness. As described in the above example, in a condition of requiring a turning operation of the electric power steering device, the motor requires a large torque and a high speed rotation together, and the control should not cause uncomfortable feeling against a driver's steering. In particular, a control to make the weak field current flow is actively used for a high speed rotation.

The first example described in PTL 1 has a problem in that a control voltage of the motor is changed from an ideal sinusoidal wave to a distorted rectangular wave and causes a torque ripple which degrades a steering feeling. As a solution, there is disclosed a method of limiting a current command value to limit the torque current and the weak field current and, specifically, a method of limiting the torque current.

The second example described in PTL 2 discloses a method of limiting the weak field current according to a DC voltage in order to solve heat caused by waste weak field current.

### CITATION LIST

### Patent Literature

PTL 1: JP 2005-119417 A

PTL 2: JP 2013-074648 A

### Non Patent Literature

NPTL 1: Shigeo Morimoto, Tomohiro Ueno, Yoji Takeda, “Wide Speed Control of Interior Permanent Magnet Synchronous Motor”, IEEJ Transactions on Industry Applications, Vol. D114 No. 6, 1994

### SUMMARY OF INVENTION

### Technical Problem

A device mounted in a vehicle such as an electric power steering device is supplied with power from a DC power source of the vehicle. Assuming a 12 V source voltage, an example of the DC power source includes a 12 V battery or a DC/DC converter which boosts down a voltage from a high voltage battery (exceeding 12 V) to 12 V such as a hybrid electric vehicle. Hereinafter, the description will be given about the 12 V battery for example.

The electric power steering device receives a large amount of current from a battery by the stationary steering or the like. In a condition that a large amount of current is output from the battery of the vehicle, the voltage is dropped by wiring resistance or by internal resistance of the battery. Therefore, the vehicle is needed to be managed for the power source to limit the current to be input to the device.

However, the power conversion devices disclosed in PTLS 1 and 2 fail to consider such a method of limiting the input current of the device to be equal to or less than a predetermined value. Therefore, the invention is to propose a method of suppressing a DC current input to the devices to be equal to or less than a predetermined value as a method of managing the power source of the vehicle, that is, a method of limiting the input current of the device connected to the DC power source.

### Solution to Problem

According to a motor control device of the invention, a maximum weak field current is conducted in a range where a DC input current of a power conversion device does not exceed a predetermined upper limit. As an embodiment of such a motor control device, the weak field current is calculated from a torque current on the basis of a DC power source voltage and a torque command value, and the control is performed to follow up the current in order to make the DC input current of the power conversion device equal to or less than a predetermined upper limit.

### Advantageous Effects of Invention

According to the invention, a DC input current of a power conversion device can be controlled to be equal to or less than a desired limit value. Further, the motor is rotated at a high speed while keeping a torque for a high power drive by conducting a torque current and a weak field current of the motor until a maximum power equal to or less than the limit value is obtained. In addition, with such a configuration, it is possible to provide a motor control device which realizes a high power drive and keeps a steering feeling having a good responsiveness with respect to an operation amount of a steering wheel like an electric power steering device.

### BRIEF DESCRIPTION OF DRAWINGS

FIG. 1 is a diagram illustrating the entire configuration of a motor control device according to an embodiment.

FIG. 2 is a diagram illustrating a locus characteristic of Id with respect to current Iq in the invention.

FIG. 3 is a diagram illustrating a configuration of an electric power steering device according to an embodiment.

FIG. 4 is a diagram illustrating an embodiment of a two-inverter configuration.

### DESCRIPTION OF EMBODIMENTS

Hereinafter, an embodiment of a power conversion device according to the invention will be described with reference the drawings. Further, the same components in the respective drawings will be denoted with the same symbols, and the redundant description will be omitted.

### First Embodiment

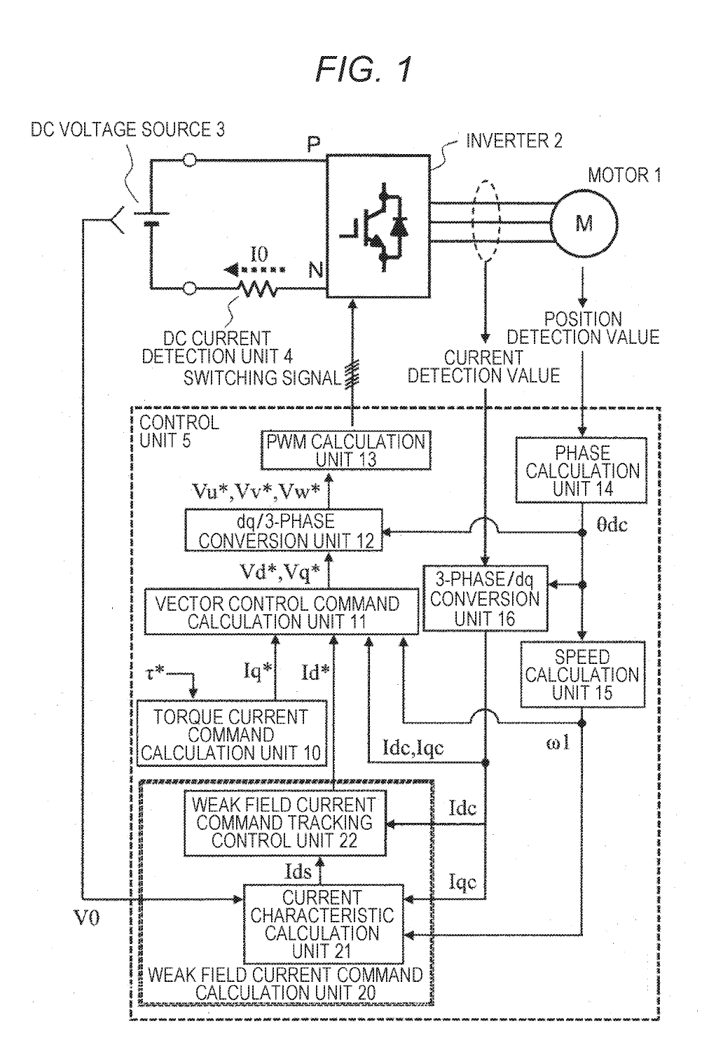

FIG. 1 is a diagram illustrating the entire configuration of a motor control device according to the invention.

A motor 1 is connected to an inverter 2 which is configured by a bridge circuit. The bridge circuit of the inverter 2 is configured by a switching device such as an IGBT or a MOSFET. The inverter 2 receives a switching signal which is output from a control unit 5. The inverter 2 drives and controls the motor 1 on the basis of the switching signal.

A DC voltage source 3 is connected to a terminal P and a terminal N on a DC side of the inverter 2. A DC current detection unit 4 is connected between the inverter 2 and the DC voltage source 3. The DC current detection unit 4 detects a DC input current I0. The detected DC input current I0 is input to the control unit 5.

The motor 1 is an AC electric motor, and a permanent magnetic synchronous motor or an induction motor for example. A battery is generally used as the DC voltage source 3, and a DC/DC converter may be connected in a hybrid electric vehicle or an electric vehicle to reduce a DC voltage from a DC voltage.

The motor control device of this embodiment uses a current sensor (not illustrated) to detect three-phase currents which are output from the inverter 2 to the motor 1. The detected values Iuc, IVc, and Iwc of the three-phase currents are input to the control unit 5. As the current sensor, a current sensor such as a CT using a hole effect may be employed. In addition, the three-phase currents which are output from an instantaneous DC current detected by the DC current detection unit 4 and input to the motor 1 may be obtained in synchronization with a switching operation timing to drive the inverter 2.

In addition, the motor control device of this embodiment is provided with a position sensor (not illustrated) which detects a phase of a rotor of the motor 1. A position detection value detected by the position sensor is input to the control unit 5. As the position sensor, any device such as a resolver, an encoder, a GMR sensor, and a hole IC may be used as long as the device can detect an angular position of the rotor. In addition, an output of a position-sensorless control may be used to estimate the phase of the rotor from the three-phase currents and the three-phase voltages of the motor.

The control unit 5 is provided with a torque current command calculation unit 10, a vector control command calculation unit 11, a dq/3-phase conversion unit 12, a PWM calculation unit 13, a phase calculation unit 14, a speed calculation unit 15, a 3-phase/dq conversion unit 16, and a weak field current command calculation unit 20. The control unit 5 is configured to include a calculation function such as a microcomputer, and a driver circuit which is necessary for driving the inverter 2. The control unit 5 drives the inverter 2 on the basis of the calculated switching signal and controls the motor 1.

The phase calculation unit 14 calculates and outputs a rotor phase θdc from the position detection value output from the position sensor which detects a rotor phase of the motor.

The speed calculation unit 15 obtains a speed of the motor from a change of the rotor phase. Specifically, an angular speed ω1 is obtained by performing a differential calculation on the rotor phase θdc.

The dq/3-phase conversion unit 12 and the 3-phase/dq conversion unit 16 convert d-q axes which are of a rotary coordinate system and a three-phase u-v-w coordinate system which is a fixed coordinate system. Specifically, a d-q axis voltage of a DC amount and a three-phase voltage of an AC amount are converted to each other on the basis of the rotor phase θdc of the motor using a dq/αβ coordinate conversion and a αβ/three-phase conversion described in Expressions (1) and (2). Further, Expressions (1) and (2) are described using voltages as an example of the dq/3-phase conversion unit 12. In the 3-phase/dq conversion unit 16, the voltages may be replaced with currents and inversely converted. In addition, there are an absolute conversion and a relative conversion in the coordinate conversion. In this description, the relative conversion is used, and all values such as an index of the motor are assumed as values based on the relative conversion. Further, asterisk (*) indicating a command value will be omitted even in the following expressions.

$$\begin{matrix}[ Expression 1 ] & \\ [ \begin{matrix}{V}_{α} \\ {V}_{β}\end{matrix} ] = [ \begin{matrix}cos {θ}_{dc} & - sin {θ}_{dc} \\ sin {θ}_{dc} & cos {θ}_{dc}\end{matrix} ] [ \begin{matrix}{V}_{d} \\ {V}_{q}\end{matrix} ] & ( 1 ) \\ [ Expression 2 ] & \\ [ \begin{matrix}{V}_{u} \\ {V}_{v} \\ {V}_{w}\end{matrix} ] = [ \begin{matrix}1 & 0 \\ - \frac{1}{2} & \frac{\sqrt{3}}{2} \\ - \frac{1}{2} & - \frac{\sqrt{3}}{2}\end{matrix} ] [ \begin{matrix}{V}_{α} \\ {V}_{β}\end{matrix} ] & ( 2 )\end{matrix}$$

Current detection values which are inputs of the 3-phase/dq conversion unit 16 are the detection values Iuc, Ivc, and Iwc of the three-phase currents flowing from the inverter 2 to the motor 1. The 3-phase/dq conversion unit 16 outputs a d-axis current detection value Idc and a q-axis current detection value Iqc by converting the coordinate above.

The dq/3-phase conversion unit 12 converts voltage command values Vq* and Vd* generated by the vector control command calculation unit 11 (described below) into three-phase voltage command values Vu*, Vv*, and Vw* on the basis of Expressions (1) and (2).

The PWM calculation unit 13 performs a pulse width modulation (PWM) to change the three-phase voltage command values Vu*, Vv*, and Vw* into a binary switching signal to drive a gate signal of the inverter 2.

The vector control command calculation unit 11 outputs voltage command values Vq* and Vd* such that a torque current command value Iq* and a weak field current command value Id* which are current command values follow up the torque current detection value Iqc and the weak field current detection value Idc which are current detection values. A voltage equation of the motor is described as Expression (3). Herein, characteristic values (constants) R1, Ld, Lq, and Ke of the motor are respectively a resistance value, a d-axis inductance value, a q-axis inductance value, and an induced voltage constant of one phase. A current controller which is designed to obtain a desired current control responsiveness is combined with a non-interacting control in which interacting terms of the d axis and the q axis are compensated so as to calculate a q-axis voltage command value Vq* and a d-axis voltage command value Vd*.

$$\begin{matrix}[ Expression 3 ] & \\ [ \begin{matrix}{V}_{d} \\ {V}_{q}\end{matrix} ] [ \begin{matrix}{R}_{1} + {pL}_{d} & - {ω}_{1} {L}_{q} \\ {ω}_{1} {L}_{d} & {R}_{1} + {pL}_{q}\end{matrix} ] [ \begin{matrix}{I}_{d} \\ {I}_{q}\end{matrix} ] + [ \begin{matrix}0 \\ {K}_{e} {ω}_{1}\end{matrix} ] & ( 3 )\end{matrix}$$

The torque current command value Iq* in Expression (3) is output from the torque current command calculation unit 10. The torque current command calculation unit 10 converts a torque command value τ* into the torque current command value Iq*. A current of Expression (4) and a relational expression of torque are used for the conversion. In a case where there is a salient pole characteristic in which Ld and Lq of the motor are substantially matched, the second term of Expression (4) becomes approximately zero, and simplified to Expression (5). The torque value and the torque current value are uniquely defined using Expression (5).

$$\begin{matrix}[ Expression 4 ] & \\ τ = \frac{3}{2} {P}_{m} \{ {K}_{e} {I}_{q} + ( {L}_{d} - {L}_{q} ) {I}_{d} {I}_{q} \} & ( 4 ) \\ [ Expression 5 ] & \\ τ = \frac{3}{2} {P}_{m} {K}_{e} {I}_{q} & ( 5 )\end{matrix}$$

The weak field current command value Id* in Expression (3) is output from the weak field current command calculation unit 20. The weak field current command calculation unit 20 calculates the weak field current command value Id* on the basis of the angular speed ω1, the current detection values Iqc and Idc, and a DC voltage V0. The weak field current command calculation unit 20 includes a current characteristic calculation unit 21 and a weak field current command tracking control unit 22.

The current characteristic calculation unit 21 calculates a current characteristic command value Ids from the angular speed ω1, the current detection value Iqc, and the DC voltage V0. The weak field current command tracking control unit 22 outputs the weak field current command value Id* to cause the weak field current detection value Idc to follow up the current characteristic command value Ids.

The current characteristic command value Ids is calculated by the following deprived relational expression. The powers of the inverter on the DC and AC sides have the relation of Expression (6).

$$\begin{matrix}[ Expression 6 ] & \\ {V}_{0} {I}_{0} = \frac{3}{2} ( {V}_{d} {I}_{d} + {V}_{q} {I}_{q} ) & ( 6 )\end{matrix}$$

When Expression (3) is substituted to Expression (6), Expression (7) is obtained.

$$\begin{matrix}[ Expression 7 ] & \\ {I}_{d}^{2} + \{ \frac{{ω}_{1}}{{R}_{1}} ( {L}_{d} - {L}_{q} ) {I}_{q} \} {I}_{d} + \{ \frac{{ω}_{1}}{{R}_{1}} {K}_{e} {I}_{q} - \frac{2 {V}_{0} {I}_{0}}{3 {R}_{1}} \} = 0 & ( 7 )\end{matrix}$$

When Expression (7) is resolved with respect to Id, Expression (8) is obtained.

$$\begin{matrix}[ Expression 8 ] & \\ {I}_{d} = \frac{1}{2} [ - \frac{{ω}_{1}}{{R}_{1}} ( {L}_{d} - {L}_{q} ) {I}_{q} \pm \sqrt{{\{ \frac{{ω}_{1}}{{R}_{1}} ( {L}_{d} - {L}_{q} ) {I}_{q} \}}^{2} - \frac{4 {ω}_{1} {K}_{e}}{{R}_{1}} {I}_{q} + \frac{8 {V}_{0} {I}_{0}}{3 {R}_{1}}} ] & ( 8 )\end{matrix}$$

Since Id is a negative value at the time of weak field control, Expression (9) is finally obtained.

$$\begin{matrix}[ Expression 9 ] & \\ {I}_{d} = \frac{1}{2} [ - \frac{{ω}_{1}}{{R}_{1}} ( {L}_{d} - {L}_{q} ) {I}_{q} - \sqrt{{\{ \frac{{ω}_{1}}{{R}_{1}} ( {L}_{d} - {L}_{q} ) {I}_{q} \}}^{2} - \frac{4 {ω}_{1} {K}_{e}}{{R}_{1}} {I}_{q} + \frac{8 {V}_{0} {I}_{0}}{3 {R}_{1}}} ] & ( 9 )\end{matrix}$$

A weak field current value obtained from Expression (9) is input to the weak field current command tracking control unit 22 as the current characteristic command value Ids. Herein, a DC current I0 may be set as a desired control value of the input current in advance, or a setting value may be changed according to a state of the DC voltage source 3.

In the weak field control unit 22, the current control is performed such that Idc follows up Ids, and the weak field current command value Id* is output. The current control is set to be equal to or less than a response of the current controller of the vector control command calculation unit 11.

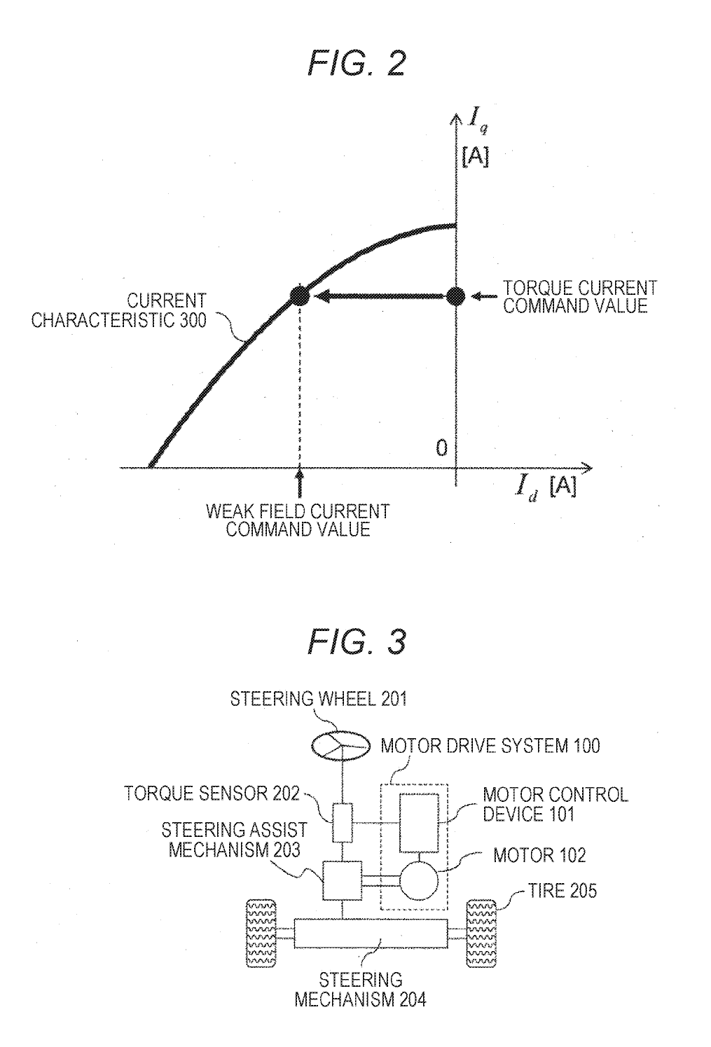

A current characteristic 300 illustrated in FIG. 2 is a characteristic of a weak field current Id with respect to a torque current Iq which is calculated from Expression (9) or Expression (10) described below. The current characteristic 300 becomes a combination of the weak field current command value Id* with respect to the torque current command value Iq* at the time when the DC current I0 is assigned as a desired control value. The motor 1 may be driven to be the current characteristic 300 by causing the weak field current detection value Idc to fallow up the weak field current command value Id* obtained by the current characteristic 300 through the current control.

In the motor control device according to this embodiment, the DC input current I0 is controlled to follow up the weak field current command value calculated on the basis of Expression (9). As a result, a high power operation can be made in which the speed of the motor is increased up to a high speed region, and a high speed responsiveness can be realized which is not obtained in the related art.

### Second Embodiment

A d-axis inductance Ld and a q-axis inductance Lq of Expression (9) are constants which are the characteristic values of the motor. In the motor of a surface magnetic type, the motor has a salient pole characteristic, and a difference between Ld and Lq becomes substantially zero. In such a salient pole motor, Expression (9) is simplified to Equation (10).

$$\begin{matrix}[ Expression 10 ] & \\ {I}_{d} = - \frac{1}{2} \sqrt{- \frac{4 {ω}_{1} {K}_{e}}{{R}_{1}} {I}_{q} + \frac{8 {V}_{0} {I}_{0}}{3 {R}_{1}}} & ( 10 )\end{matrix}$$

In the case of the salient pole motor, the current characteristic calculation unit 21 inputs the weak field current value Id obtained from Expression (10) to the weak field current command tracking control unit 22 as the current characteristic command value Ids. In addition, the current characteristic calculation unit 21 may be simplified to Expression (10) similarly to the salient pole when a difference between Ld and Lq is ignored even in the case of the salient pole motor.

According to this embodiment, the weak field current command value to limit the input current can be simply calculated. As a result, a calculation load of the control unit 5 can be reduced, and an inexpensive system can be established without using an expensive microcomputer.

### Third Embodiment

FIG. 3 is a diagram illustrating a configuration of an electric power steering device according to this embodiment. FIG. 3 illustrates an electric power steering device which steers a vehicle in an advancing direction. A steering mechanism 204 is moved through a torque sensor 202 and a steering assist mechanism 203 by operating a steering wheel 201. Therefore, a direction of a tire 205 is turned to steer the vehicle in an advancing direction. The steering assist mechanism 203 uses a resultant force of a manual steering force of the steering wheel 201 and a steering force electrically assisted by a motor drive system 100 to output a steering force to move the steering mechanism 204. The motor drive system 100 is configured such that a motor control device 101 obtains a shortage of the manual steering force as an electrically-assisted steering force from the output obtained by the torque sensor 202 so as to drive a motor 102.

The motor drive system 100 is configured by the motor control device 101 which includes the inverter 2, the DC current detection unit 4, and the control unit 5 illustrated in FIG. 1, and the motor 102. The DC voltage source 3 is configured by a battery unlike FIG. 3, and connected to the motor drive system 100.

The electric power steering device according to this embodiment limits the DC input current to suppress the output voltage of the DC voltage source 3 from being dropped. Therefore, a high power operation of the electric power steering device is enabled, and a high speed responsiveness of the steering force with respect to the turning operation of the steering wheel can be realized.

### Fourth Embodiment

In the electric power steering device according to this embodiment, a steering amount of the steering wheel 201 is detected as a shortage of the manual steering force by the torque sensor 202. An amount of change obtained by differentiating the steering amount becomes a steering speed and an amount of change obtained by secondarily differentiating the steering amount becomes a steering acceleration. In a condition where the steering speed and the steering acceleration are small, it shows a state where a rapid turning is not required, and the output of the electric power steering device may be small.

Therefore, in a case where the steering speed and the steering acceleration are equal to or less than a predetermined value, a setting value for limiting the DC current I0 is changed to a value smaller than the predetermined value so as to suppress the weak field current from being conducted. A relation between a steering condition of the vehicle and a steering amount of the steering wheel 201 is obtained in advance for the predetermined values of the steering speed and the steering acceleration are obtained in advance.

In this embodiment, a high speed responsiveness of the steering force with respect to the turning operation of the steering wheel 201 can be realized by liming the DC input current. In addition, it is possible to provide an electric power steering device having a high efficiency by suppressing the weak field current from being conducted in a condition where a change of the steering amount is small and a high speed responsiveness is not required.

### Fifth Embodiment

An electric power steering device according to this embodiment inputs a running speed of the vehicle to the motor control device 101 as a vehicle speed. In a high speed running where the vehicle speed is equal to or more than a predetermined value, the vehicle may be turned due to avoiding risk or changing lane. However, the vehicle may straightly run most of time while setting the value of steering amount is almost zero.

Therefore, the conducting of the weak field current can be suppressed by changing a setting value to limit the DC current I0 to be smaller than the predetermined value, and the current value at the time of straight running can be reduced. In a case where the vehicle is turned steeply, the setting value to limit the DC current I0 returns to the predetermined value.

In this embodiment, a high efficiency can be realized by suppressing the weak field current in a low output condition which occupies a lot at the time of straight running. Further, it is possible to provide an electric power steering device which satisfies a high speed responsiveness required in the steep turning.

### Sixth Embodiment

An electric power steering device according to this embodiment controls a turn-back steering in a parking operation of the vehicle. In the turning back in the parking operation of the vehicle, the steering amount of the steering wheel 201 becomes large on a condition where the vehicle speed is equal to or less than a predetermined value. Since the steering at this time is not needed for an emergency situation such as avoiding risk, a high speed responsiveness is not necessarily required. Therefore, the conducting of the weak field current can be suppressed by changing the setting value to limit the DC current I0 to be smaller than a predetermined value in synchronization with that the battery of the DC voltage source 3 is degraded.

In this embodiment, a high efficiency operation can be possible by suppressing the weak field current in a steering operation not necessarily required for an emergency situation. As a result, the output can be suppressed in synchronization with that the battery is degraded. Further, it is possible to provide an electric power steering device in which an influence of a voltage drop caused by an internal resistance increased by the degraded battery can be suppressed.

### Seventh Embodiment

The DC voltage source 3 is generally a battery. A degraded state of the battery is always diagnosed, and the diagnosis result of the battery state is input to the motor control device 101. When the battery is degraded, the internal resistance of the battery is increased, and an output voltage is dropped at a high load. The motor control device according to this embodiment suppresses the conducting of the weak field current by changing the setting value to limit the DC current I0 to be smaller than a predetermined value according to the output voltage or the diagnosis result of the battery. Alternatively, the output Ids of the current characteristic calculation unit 21 is always set to almost zero in order to stop this control.

In this embodiment, it is possible to suppress the output voltage of the battery from being dropped by controlling the DC input current according to the state of the battery. Therefore, with the motor control device according to this embodiment, it is possible to provide a stable electric power steering device which avoids a failure of the power source which is caused by a steep reduction of the battery voltage.

### Eighth Embodiment

In the motor control device according to this embodiment, the DC voltage source 3 is a capacitor connected in parallel with a DC/DC converter which boosts up or down a DC voltage to a DC voltage. In a case where the output capacitance of the DC voltage source 3 is reduced, the conducting of the weak field current can be suppressed by changing the setting value of the DC current I0 to be smaller than a predetermined value.

In this embodiment, it is possible to prevent the output voltage of the DC voltage source 3 from being reduced by controlling the DC input current according to the reduction of the output capacity of the DC voltage source 3. Further, it is possible to provide a stable electric power steering device.

### Ninth Embodiment

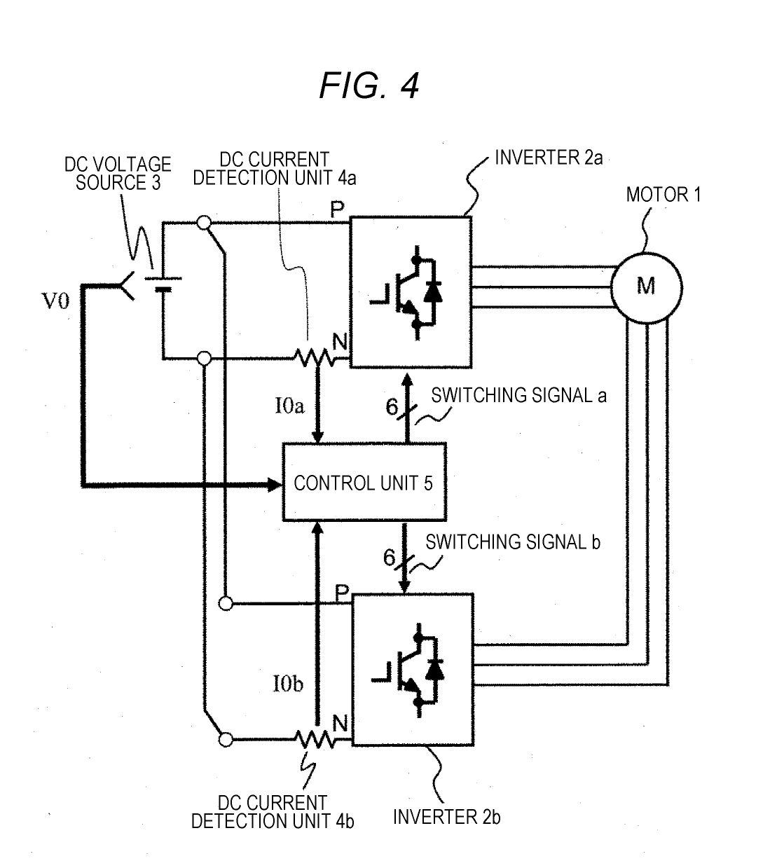

FIG. 4 is a diagram illustrating a configuration of a motor control device according to this embodiment. This embodiment is different from the embodiment illustrated in FIG. 1 in that an inverter 2a and an inverter 2b are connected in parallel with respect to the motor 1. In addition, there are provided DC current detection units 4a and 4b.

A basic operation of the control unit 5 is similar to the embodiment illustrated in FIG. 1, and the inverter 2a is driven by a switching signal a on the basic of a DC current I0a detected by the DC current detection unit 4a, and the inverter 2b is driven by a switching signal b on the basis of a DC current I0b detected by the DC current detection unit 4b. The inverter 2a and the inverter 2b control the motor 1 in a coordinated manner. The coordinating control of the inverter 2a and the inverter 2b can be realized by providing the control units 5 illustrated in FIG. 1 as many as the number of inverters in parallel. For the purpose of reducing a calculation load, the phase calculation unit 14 and the speed calculation unit 15 may be provided to have the same configuration.

In this embodiment, the weak field currents of the inverters 2a and 2b can be individually suppressed by individually changing the setting values to limit the DC current I0a and the DC current I0b to be a predetermined value or to be a value smaller than the predetermined value. For example, heat generated as the current of the inverters is increased can be dispersed to the plurality of inverters by sequentially switching the DC current I0a and the DC current I0b to be limited. Therefore, it is possible to perform a high power operation in which the speed of the motor is increased up to a high speed region and a high speed responsiveness can be realized which is not obtained in the related art. Further, it is possible to provide a motor control device having a high reliability by dispersing the heat generated by the conducting of the weak field current.

### Tenth Embodiment

An electric power steering device in this embodiment is configured such that the motor control device provided with the plurality of inverters illustrated in FIG. 4 is configured as the motor control device 101 illustrated in FIG. 3.

In this embodiment, the weak field currents of the inverters 2a and 2b can be individually suppressed by individually changing the setting values to limit the DC current I0a and the DC current I0b to be a predetermined value or to be a value smaller than the predetermined value. As a result, a high power operation of the electric power steering device is possible, so that it is possible to realize a high responsiveness of the steering force with respect to the turning of the steering wheel. In addition, since the output voltage of the DC voltage source 3 is prevented from being reduced, it is possible to prevent a malfunction caused by a voltage drop of the power source onto other devices which are connected in parallel and mounted in the vehicle. Further, it is possible to provide an electric power steering device which contributes to the safety of the vehicle.

### REFERENCE SIGNS LIST

1 motor
2 inverter
3 DC voltage source
4 DC current detection unit
5 control unit
10 torque current command calculation unit
11 vector control command calculation unit
12 dq/3-phase conversion unit
13 PWM calculation unit
14 phase calculation unit
15 speed calculation unit
16 3-phase/dq conversion unit
20 weak field current command calculation unit
21 current characteristic calculation unit
22 weak field current command tracking control unit
100 motor drive system
101 motor control device
102 motor
201 steering wheel
202 torque sensor
203 steering assist mechanism
204 steering mechanism
205 tire
300 current characteristic

1. A motor control device, comprising:
an inverter that converts a DC input current from a DC voltage source into an AC current on the basis of a rotor phase of a motor and outputs the AC current,
wherein a maximum weak field current is conducted in a range where an input current to the inverter does not exceed a predetermined upper limit.

2. The motor control device according to claim 1,
wherein the weak field current is conducted to reduce a difference between the upper limit of the DC input current and a current consumed by the motor.

3. The motor control device according to claim 2,
wherein a current upper limit of the motor is obtained on the basis of a predetermined upper limit and an output voltage of the DC voltage source.

4. The motor control device according to claim 2,
wherein the current consumed by the motor is obtained on the basis of a torque current and a rotation speed of the motor.

5. The motor control device according to claim 1,
wherein a plurality of the inverters are provided, and
wherein a maximum weak field current is conducted in a range where a DC input current to each of the plurality of the inverters does not exceed a predetermined upper limit which is individually set with respect to each inverter.

6. An electric power steering device, comprising:
the motor control device according to claim 1;
a turning mechanism that performs a turning operation according to a steering amount of a steering wheel; and
the motor that applies a steering force to the turning mechanism.

7. The electric power steering device according to claim 6,
wherein the DC input current is adjusted and controlled according to a steering state.

8. The electric power steering device according to claim 7,
wherein the steering amount is determined as almost zero at a predetermined vehicle speed or more, and the weak field current of which the current value is smaller than a predetermined upper limit of the DC input current is conducted.

9. The electric power steering device according to claim 7,
wherein, in a case where a steering speed obtained from the steering amount is equal to or less than a predetermined value, the weak field current of which the current value is smaller than a predetermined upper limit of the DC input current is conducted.

10. The electric power steering device according to claim 7,
wherein, in a case where a steering acceleration obtained from the steering amount is equal to or less than a predetermined value, the weak field current of which the current value is smaller than a predetermined upper limit of the DC input current is conducted.

11. The electric power steering device according to claim 7,
wherein, even in a case where the steering amount is larger than a predetermined value at a predetermined vehicle speed or less, the weak field current of which the current value is smaller than a predetermined upper limit of the DC input current is conducted.

12. The electric power steering device according to claim 6,
wherein the DC voltage source is a battery, and the weak field current is conducted such that a predetermined upper limit of the DC input current is adjustably controlled to be a smaller value according to an output voltage of the battery.

13. The electric power steering device according to claim 12,
wherein, in a case where the output voltage of the battery is equal to or less than a predetermined value, the weak field current is controlled to be small approaching almost zero or to stop the control.

14. The electric power steering device according to claim 6,
wherein a DC voltage converter which boosts up or down the DC voltage source from a DC voltage to a DC voltage and a capacitor connected in parallel to an output of the DC voltage converter are configured.
